(19) United States
(12) Patent Application Publication
(10) Pub. No.: US 2015/0049474 A1
(43) Pub. Date: Feb. 19, 2015

(54) LED TUBE HAVING LONG INTERNAL CREEPAGE DISTANCES

(71) Applicant: LUXUL TECHNOLOGY INCORPORATION, New Taipei City (TW)

(72) Inventors: Cheng-Hung PAN, New Taipei City (TW); Yung-Ta HUNG, New Taipei City (TW); Cheng-Hsien CHEN, New Taipei City (TW)

(73) Assignee: LUXUL TECHNOLOGY INCORPORATION, New Taipei City (TW)

(21) Appl. No.: 14/166,591

(22) Filed: Jan. 28, 2014

(30) Foreign Application Priority Data
Aug. 15, 2013 (TW) 102129258

(51) Int. Cl. F21K 99/00; F21V 29/00

(52) U.S. Cl. CPC F21K 9/175; F21V 29/004
USPC 362/218

(57) ABSTRACT

An LED tube has a tube body, an LED light board and two caps. The tube body has a translucent tube shell and a heat dissipating seat. The translucent tube shell has two openings and a gap. The heat dissipating seat is mounted in the gap. The LED light board is mounted in the tube body and has a luminous surface, wherein two opposite ends of the LED light board extend out of the heat dissipating seat. The luminous surface has four electrical connecting parts, wherein each two electrical connecting parts are respectively mounted near a corresponding one of the two opposite ends, thus, the four electrical connecting parts are mounted away from the heat dissipating seat to extend internal creepage distances between the four electrical connecting parts and the heat dissipating seat, and further increase electrical safety of the LED tube.

### BACKGROUND OF THE INVENTION

1. Field of the Invention

The present invention relates to a light emitting diode (LED) tube and more particularly to an LED tube having long internal creepage distances.

2. Description of Related Art

LEDs have features of small volume, high luminous efficiency and long service life. Thus, LED tubes using LEDs as light sources have become more and more common.

With reference to FIG. 18, a conventional LED tube has a heat dissipating seat 60, an LED light board 70, a translucent tube shell 80 and two caps 90.

The heat dissipating seat 60 is semi-cylindrical and has a rectangular flat surface, a convex surface, multiple fins 61 and two slide tracks 62. The rectangular flat surface has two opposite long sides and two opposite short sides. The multiple fins 61 are formed concave on the convex surface, and the two slide tracks 62 are respectively formed on the two long sides of the flat surface.

The LED light board 70 is rectangular and has two opposite long sides, two opposite short sides vertically connected to the two long sides, four electrical connecting parts 71 and multiple LED units 72. The two long sides of the LED light board 70 are slidably mounted in the two slide tracks 62 respectively. Thus, the LED light board 70 is mounted on the flat surface of the heat dissipating seat 60, and the two short sides of the LED light board 70 are respectively in alignment with the two short sides of the flat surface. Each two of the four electrical connecting parts 71 are mounted on the LED light board 70 and near a corresponding short side of the LED light board 70. The multiple LED units 72 are mounted at intervals on the LED light board 70 in a longitudinal direction of the LED light board 70.

The translucent tube shell 80 is semi-cylindrical and is connected to the heat dissipating seat 60 to form a tube body, wherein the translucent tube shell 80 faces the multiple LED units 72 of the LED light board 70.

Each cap 90 is sleeved on a corresponding end of the tube body and has two electrode pins 91 respectively and electrically connected to two of the electrical connecting parts 71 that are adjacent to the corresponding end.

When the LED tube is mounted in a lamp holder and is switched on, the LED light board 70 obtains power through the four electrode pins 91 of the two caps 90 and glows by the multiple LED units 72. Heat produced by the functioning LED light board 70 is conducted to the heat dissipating seat 60 and further dissipated by the multiple fins 61.

With reference to FIG. 19, the two opposite short sides of the LED light board 70 are aligned with the heat dissipating seat 60, wherein the electrical connecting parts 71 are mounted near the short sides of the LED light board 70, that is, the electrical connecting parts 71 are mounted near the heat dissipating seat 60. Besides, the electrical connecting parts 71 are also mounted near the two slide tracks 62. The electrical connecting parts 71 are electrically conductive elements, and the heat dissipating seat 60 and the two slide tracks 62 are both made of metal, which is highly conductive. A creepage distance d1 between the electrical connecting part 71 and the two slide tracks 62 is relatively short. When the LED tube functions, the electrical connecting parts 71 obtain a high voltage power from the caps 90. A surface of the LED light board 70 around the electrical connecting parts 71 may be electrically polarized due to the high voltage power obtained by the electrical connecting parts 71. The electrical connecting parts 71 and the slide tracks 62 may be conducted through the polarized surface causing short-circuit between the electrical connecting parts 71 and the slide tracks 62 damaging the LED tube.

Furthermore, each cap 90 is only sleeved on a corresponding end of the tube body consisting of the heat dissipating seat 60 and the translucent tube shell 80, that is, a connection between each cap 90 and the tube body is not stable. When an unexpected force is applied on the LED tube, the caps 90 are to rotate easily and cause a deviation of the illumination angle of the LED tube.

### SUMMARY OF THE INVENTION

The main objective of the invention is to provide an LED tube having long internal creepage distances.

The LED tube comprises a tube body, an LED light board and two caps. The tube body has a translucent tube shell and a heat dissipating seat. The translucent tube shell has two openings, a gap formed through the translucent tube shell along a longitudinal direction of the translucent tube shell, and two side walls separated by the gap. The heat dissipating seat is mounted in the gap. The LED light board is mounted in the tube body and has two opposite sides, two opposite ends, a back surface and a luminous surface opposite to the back surface, wherein a length of the LED light board in a longitudinal direction of the LED light board is longer than a length of the heat dissipating seat in a longitudinal direction of the heat dissipating seat. The two ends of the LED light board are connected to the two sides of the LED light board, wherein the two ends of the LED light board extend out of the heat dissipating seat. The luminous surface faces toward the translucent tube shell and has four electrical connecting parts mounted on the luminous surface, wherein each two electrical connecting parts are mounted near a corresponding one of the two ends of the LED light board. The back surface abuts the heat dissipating seat. The two caps are respectively mounted on the two openings of the translucent tube shell, wherein each cap has two electrically and respectively connected to a corresponding one of the electrical connecting parts of the LED light board.

The two ends of the LED light board both extend out of the heat dissipating seat and the two electrical connecting parts are respectively mounted near the two ends, that is, the two electrical connecting parts are mounted away from the heat dissipating seat to extend creepage distances between the two electrical connecting parts and the heat dissipating seat, and electrical safety of the LED tube in accordance with the present invention is improved.

Another objective of the invention is to provide an LED tube having caps firmly mounted on the LED tube.

The heat dissipating seat further comprises a top surface and a bottom surface. The bottom surface has multiple fins and two semi-annular grooves. The multiple fins are formed on the bottom surface and extend downward from the bottom surface. The two semi-annular grooves are respectively formed on two adjacent fins of the multiple fins and face each other. Each cap further comprises a screw having a screw head and a screw rod. The screw rod is mounted through the cap and between the two semi-annular grooves of the heat dissipating seat, and the screw head abuts the cap to screw the cap on a corresponding one of the two openings of the translucent tube shell.

In conclusion, the two caps are firmly mounted on the openings of the translucent tube shell via the two semi-annular grooves of the heat dissipating seat and the screws of the two caps.

### BRIEF DESCRIPTION OF THE DRAWINGS

FIG. 1 is a partial exploded view of a first embodiment of an LED tube in accordance with the present invention;

FIG. 2 is an exploded view of the LED tube in FIG. 1;

FIG. 3 is a side view in cross section of the LED tube in FIG. 1;

FIG. 4 is a top view in cross section of the LED tube in FIG. 1;

FIG. 5 is a front view in cross section of the LED tube in FIG. 1 without a cap;

FIG. 6 is a partial exploded view of a second embodiment of an LED tube in accordance with the present invention;

FIG. 7 is an exploded view of the LED tube in FIG. 6;

FIG. 8 is a side view in cross section of the LED tube in FIG. 6;

FIG. 9 is a top view in cross section of the LED tube in FIG. 6;

FIG. 10 is a partial exploded view of a third embodiment of an LED tube in accordance with the present invention;

FIG. 11 is an exploded view of the LED tube in FIG. 10;

FIG. 12 is a side view in cross section of the LED tube in FIG. 10;

FIG. 13 is a top view in cross section of the LED tube in FIG. 10;

FIG. 14 is a partial exploded view of a fourth embodiment of an LED tube in accordance with the present invention;

FIG. 15 is an exploded view of the LED tube in FIG. 14;

FIG. 16 is a side view in cross section of the LED tube in FIG. 14;

FIG. 17 is a top view in cross section of the LED tube in FIG. 14;

FIG. 18 is a partial exploded view of a conventional LED tube; and

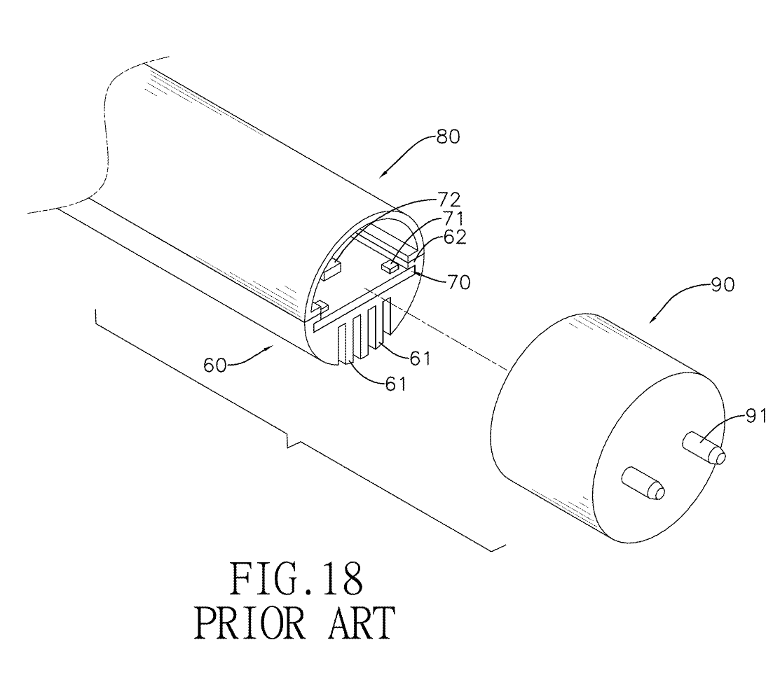

FIG. 19 is a top view in cross section of the conventional LED tube in FIG. 18.

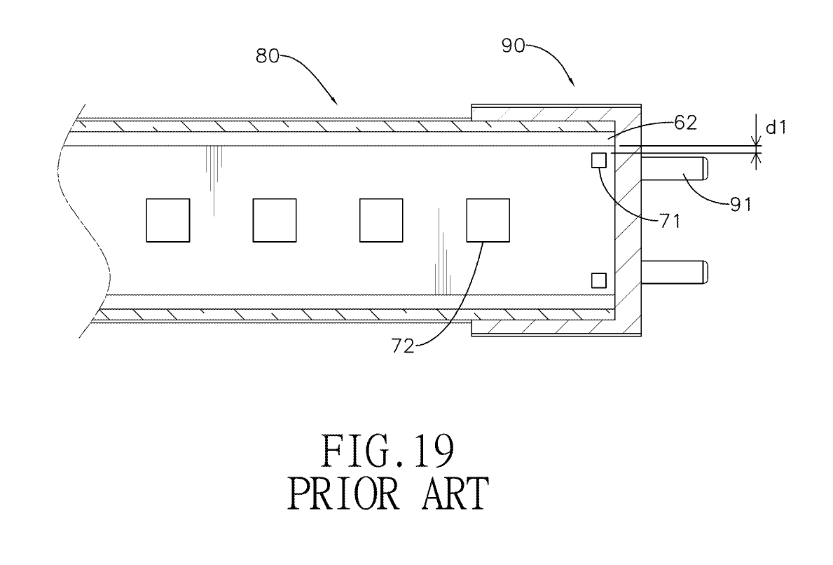

### DETAILED DESCRIPTION OF THE PREFERRED EMBODIMENTS

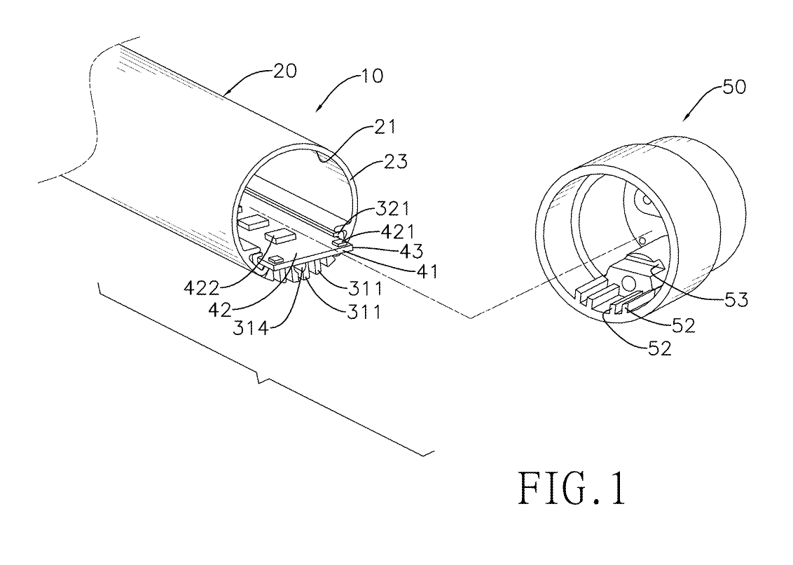

With reference to FIGS. 1 to 3, a first embodiment of an LED tube in accordance with the present invention comprises a tube body 10, an LED light board 40 and two caps 50.

The tube body 10 comprises a translucent tube shell 20 and a heat dissipating seat 30.

The translucent tube shell 20 is electrically insulating and has two openings 21, a gap 22 and two side walls 23, two first ribs 24, two second ribs 25 and two first slide tracks 26. The gap 22 is formed through the translucent tube shell 20 along a longitudinal direction of the translucent tube shell 20. The two side walls 23 are separated by the gap 22. The two first ribs 24 are respectively formed on the two side walls 23 and adjacent to the gap 22. The two second ribs 25 are respectively formed on the two side walls 23, and respectively located above the two first ribs 24. Each first slide track 26 is formed between a corresponding one of the side walls 23, the first rib 24 formed on said corresponding side wall 23, and the second rib 25 formed on said corresponding side wall 23.

The heat dissipating seat 30 is mounted in the gap 22 of the translucent tube shell 20 and the heat dissipating seat 30 is made of metal. The heat dissipating seat 30 has two opposite sides in parallel to a longitudinal direction of the heat dissipating seat 30, a bottom surface 31 and a top surface 32 opposite to the bottom surface 31. The bottom surface 31 faces downward and has multiple fins 311 and two semi-annular grooves 314. The multiple fins 311 extend downward from the bottom surface 31. The two semi-annular grooves 314 are respectively formed on two adjacent fins 311 of the multiple fins 311 and face each other. The top surface 32 has two slide bars 321 and two slide tracks 322. The two slide bars 321 extend upward from the top surface 32 and respectively along the two opposite sides of the heat dissipating seat 30, wherein the two slide tracks 322 are respectively formed concave on the two slide bars 321 and face each other.

The LED light board 40 is mounted in the tube body 10 and has two opposite sides slidably mounted in the two slide tracks 322 respectively, two opposite ends 43 connected to the two opposite sides of the LED light board 40, a back surface 41, and a luminous surface 42 opposite to the back surface 41, wherein a length of the LED light board 40 in a longitudinal direction of the LED light board 40 is longer than a length of the heat dissipating seat 30 in the longitudinal direction of the heat dissipating seat 30. The two ends 43 are respectively near the two openings 21 of the translucent tube shell 20 and extend out of the heat dissipating seat 30. The back surface 41 abuts the top surface 32 of the heat dissipating seat 30. The luminous surface 42 has four electrical connecting parts 421 and multiple LED units 422. Each two electrical connecting parts 421 are mounted on the luminous surface 42 and near a corresponding one of the two opposite ends 43. The multiple LED units 422 are mounted at intervals on the luminous surface 42 along the longitudinal direction of the LED light board 40.

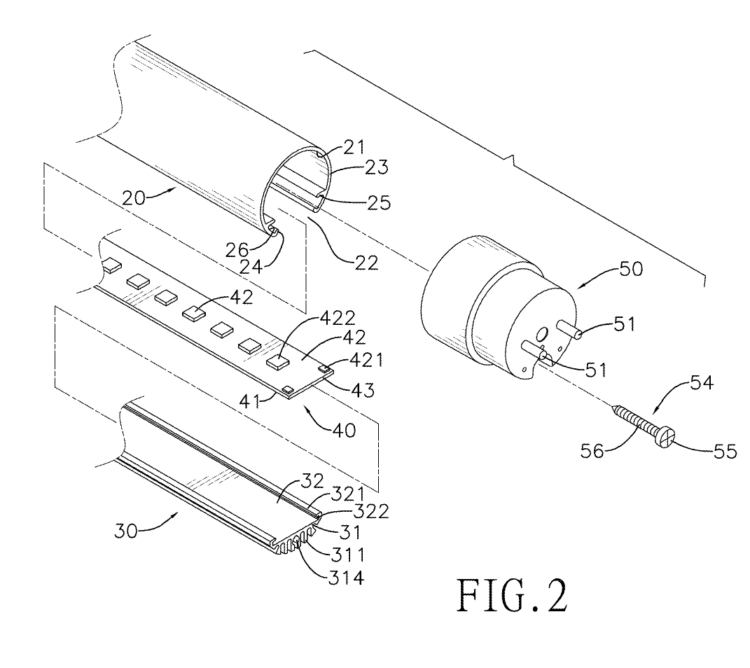

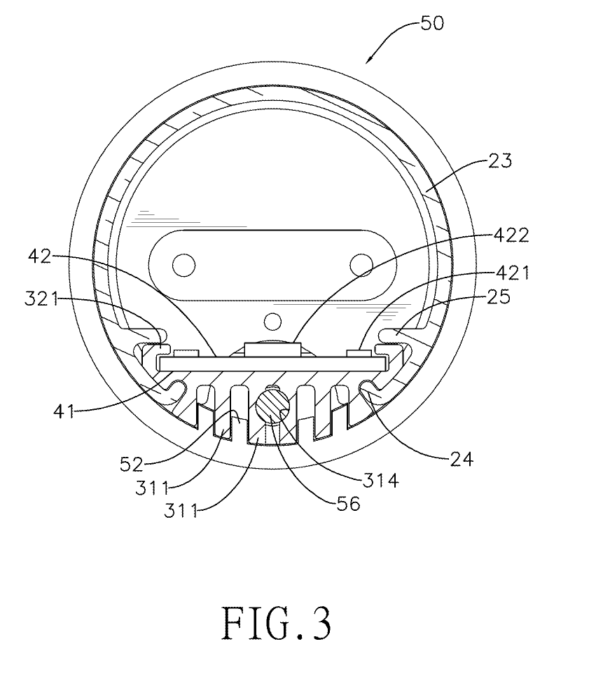

The caps 50 are respectively sleeved on the two openings 21 of the translucent tube shell 20. Each cap 50 has an inner wall, two electrode pins 51, multiple fin fixing parts 52 and a board fixing groove 53. The two electrode pins 51 are mounted through the cap 50 and electrically connected to two corresponding ones of the electrical connecting parts 421 respectively. The multiple fin fixing parts 52 are formed on the inner wall of the cap 50, wherein each fin fixing part 52 is mounted between two adjacent fins 311 of the multiple fins 311. The board fixing groove 53 is formed in the cap 50, wherein each end 43 of the LED light board 40 is mounted in a corresponding one of the board fixing grooves 53. Furthermore, with reference to FIGS. 2 and 3, each cap 50 further has a screw 54, wherein the screw 54 has a screw head 55 and a screw rod 56 connected to the screw head 55. The screw rod 56 is mounted through the cap 50 and between the two semi-annular grooves 314 of the heat dissipating seat 30, and the screw head 55 abuts the cap 50 to screw the cap 50 on a corresponding one of the openings 21 of the translucent tube shell 20.

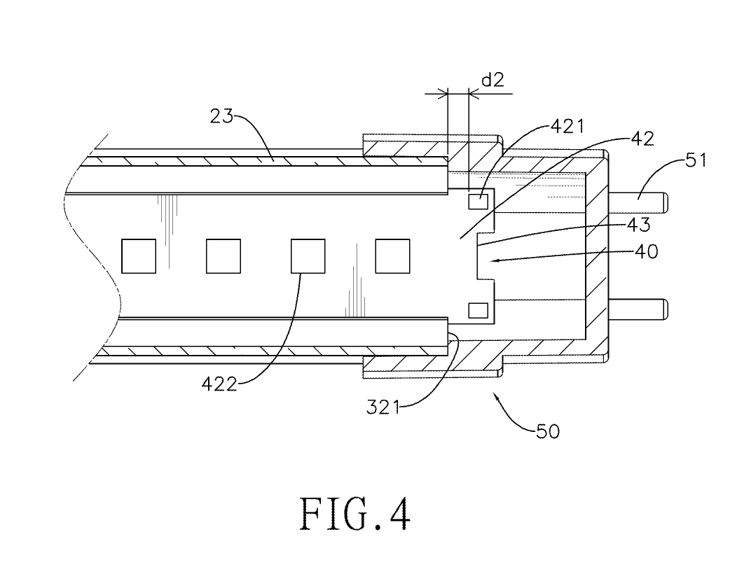

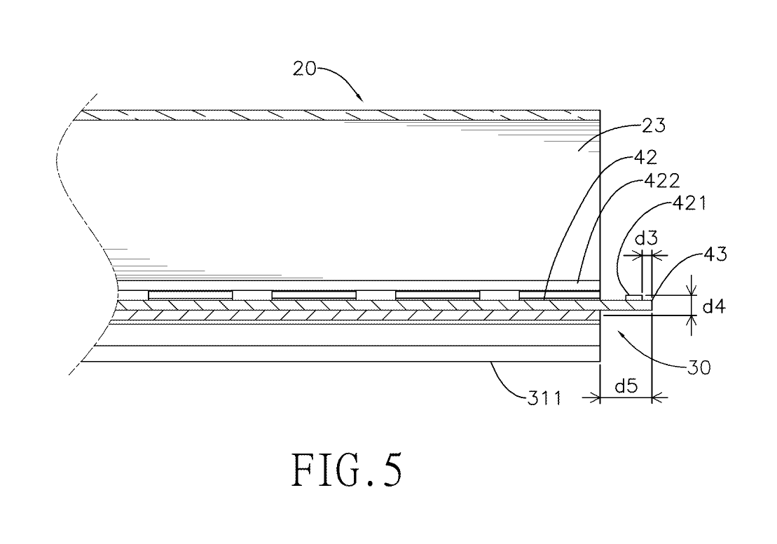

With reference to FIGS. 4 and 5, the length of the LED light board 40 in the longitudinal direction of the LED light board 40 is longer than the length of the heat dissipating seat 30 in the longitudinal direction of the heat dissipating seat 30. The two ends 43 of the LED light board 40 are respectively near the two openings 21 of the translucent tube shell 20 and extend out of the heat dissipating seat 30. Each two electrical connecting parts 421 are mounted near a corresponding one of the ends 43, that is, a creepage distance d2 between the electrical connecting part 421 and the slide bar 321 of the heat dissipating seat 30 is longer than a creepage distance d1 of the conventional LED tube. Furthermore, a creepage distance is defined between the electrical connecting part 421 and an end of the heat dissipating seat 30, wherein the creepage distance equals a sum of a distance d3 between the electrical connecting part 421 and an edge of the LED light board 40, a thickness d4 of the LED light board 40 and a distance d5 between the edge of the LED light board 40 and the heat dissipating seat 30. In conclusion, by mounting the electrical connecting parts 421 near the two opposite ends 43 of the lengthened LED light board 40, an internal creepage distance between the electrical connecting parts 421 and the heat dissipating seat 30 can be extended to improve electrical safety of the LED tube in accordance with the present invention.

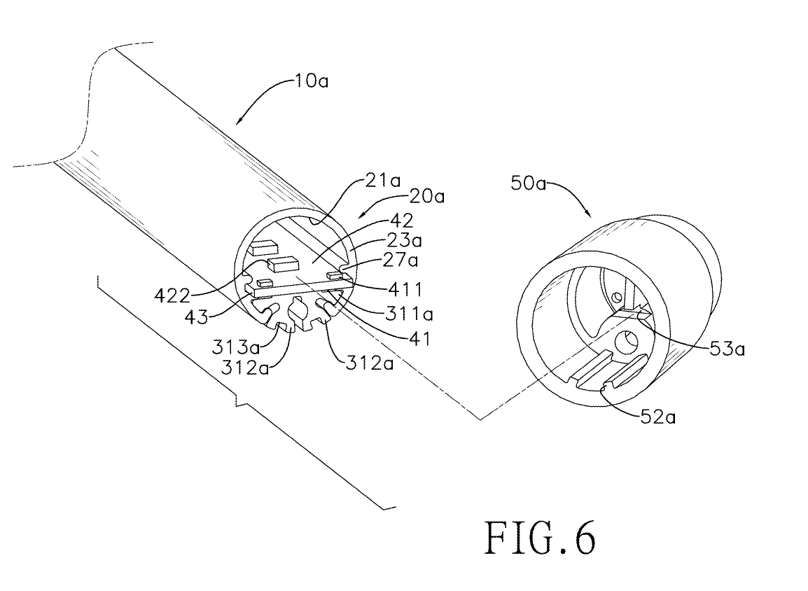

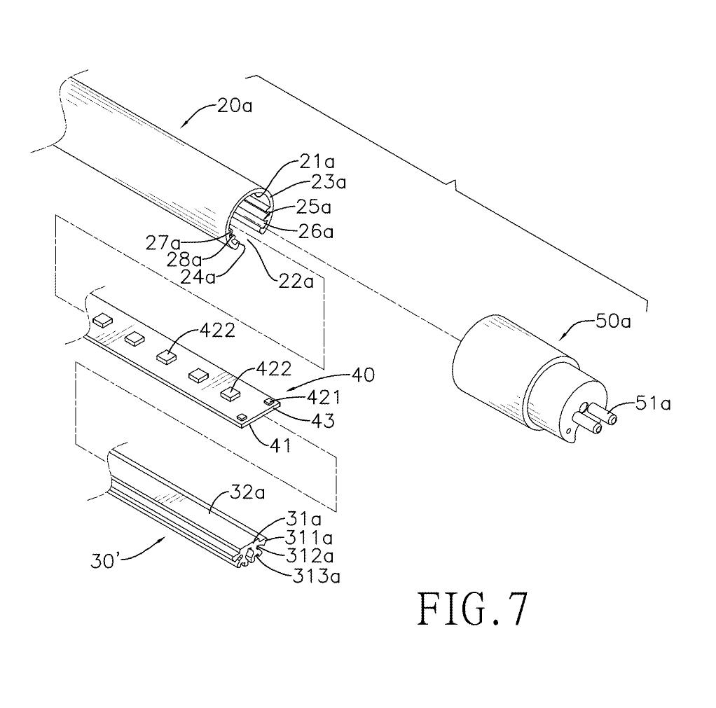

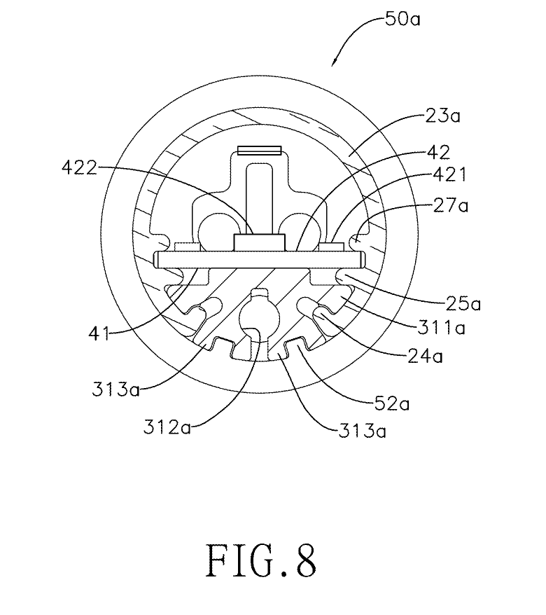

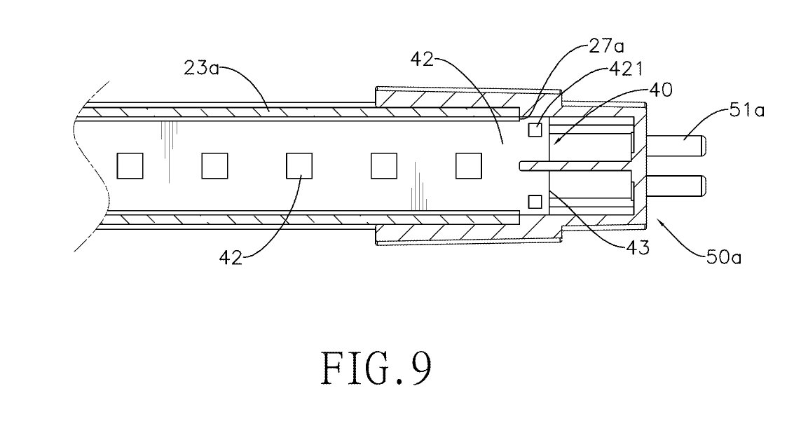

With reference to FIGS. 6 to 9, a second embodiment of an LED tube in accordance with the present invention comprises a tube body 10a, an LED light board 40 and two caps 50a, wherein a structure of the LED light board 40 of the second embodiment is similar to that of the first embodiment. Therefore, description of the structure of the LED light board 40 will not be repeated in following paragraphs.

The tube body 10a comprises a translucent tube shell 20a and a heat dissipating seat 30a.

The translucent tube shell 20a is electrically insulating and has two openings 21a, a gap 22a, two side walls 23a, two first ribs 24a, two second ribs 25a, two first slide tracks 26a, two third ribs 27a and two second slide tracks 28a. The gap 22a is formed through the translucent tube shell 20a along a longitudinal direction of the translucent tube shell 20a. The two side walls 23a are separated by the gap 22a. The two first ribs 24a are respectively formed on the two side walls 23a and adjacent to the gap 22a. The two second ribs 25a are respectively formed on the two side walls 23a, and are respectively located above the two first ribs 24a. Each first slide track 26a is formed between a corresponding one of the side walls 23a, the first rib 24a formed on said corresponding side wall 23a, and the second rib 25a formed on said corresponding side wall 23a. The two third ribs 27a are respectively formed on the two side walls 23a and are respectively located above the two second ribs 25a. Each second slide track 28a is formed between a corresponding one of the side wall 23a, the second rib 25a formed on said corresponding side wall 23a, and the third rib 27a formed on said corresponding side wall 23a.

The heat dissipating seat 30a is mounted in the gap 22a of the translucent tube shell 20a and ais made of metal. The heat dissipating seat 30a has two opposite sides along a longitudinal direction of the heat dissipating seat 30a, a bottom surface 31a and a top surface 32a opposite to the bottom surface 31a. The bottom surface 31a faces downward and has two slide bars 311a, two fins 312a and two fork parts 313a. The two slide bars 311a extend from the bottom surface 31a and respectively along the two opposite sides of the heat dissipating seat 30a, wherein the two slide bars 311a are slidably mounted in the two first slide tracks 26a of the translucent tube shell 20a respectively. Each fin 312a extends downward from the bottom surface 31a. The two fork parts 313a are respectively formed on the two fins 312a to increase a radiating area of the two fins 312a.

In this embodiment, the two opposite sides of the LED light board 40 are slidably mounted in the two second slide tracks 28a of the translucent tube shell 20a respectively.

The caps 50a are respectively sleeved on the two openings 21a of the translucent tube shell 20a. Each cap 50a has an inner wall, two electrode pins 51a and two fin fixing parts 52a. The two electrode pins 51a are mounted through the cap 50a and are electrically connected to two corresponding ones of the electrical connecting parts 421 respectively. The two fin fixing parts 52a are formed on the inner wall of the cap 50a and respectively correspond in position to the two fork parts 313a of the two fins 312a.

According to the above description, the two opposite sides of the heat dissipating seat 30a are slidably mounted in the two first slide tracks 26a respectively and the two opposite sides of the LED light board 40 are slidably mounted in athe two second slide tracks 28a of the electrically insulating translucent tube shell 20a respectively, that is, the LED light board 40 is not mounted on the metal heat dissipating seat 30a. Only the back surface 41 of the LED light board 40 abuts the top surface 32 of the heat dissipating seat 30, and the luminous surface 42 is distal from the heat dissipating seat 30. Therefore, internal creepage distances of the LED tube in accordance with the present is further extended to improve the electrical safety of the LED tube in accordance with the present invention.

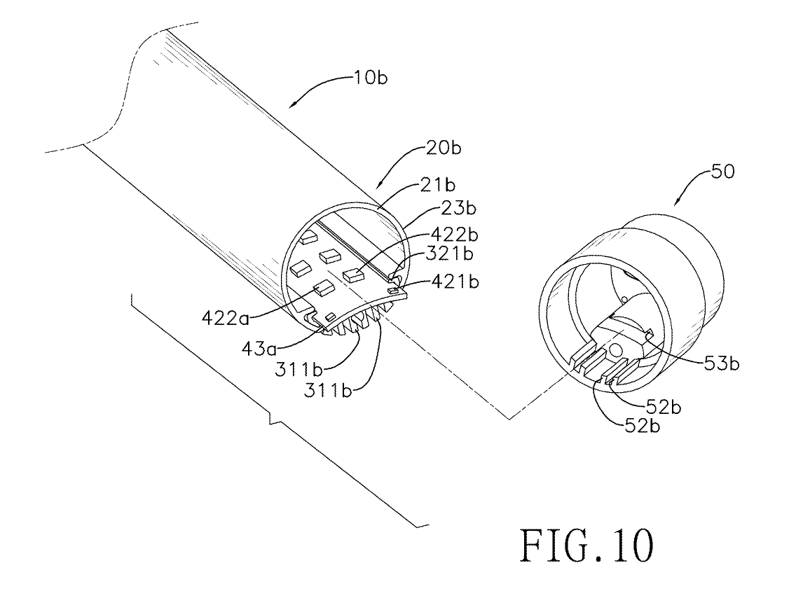

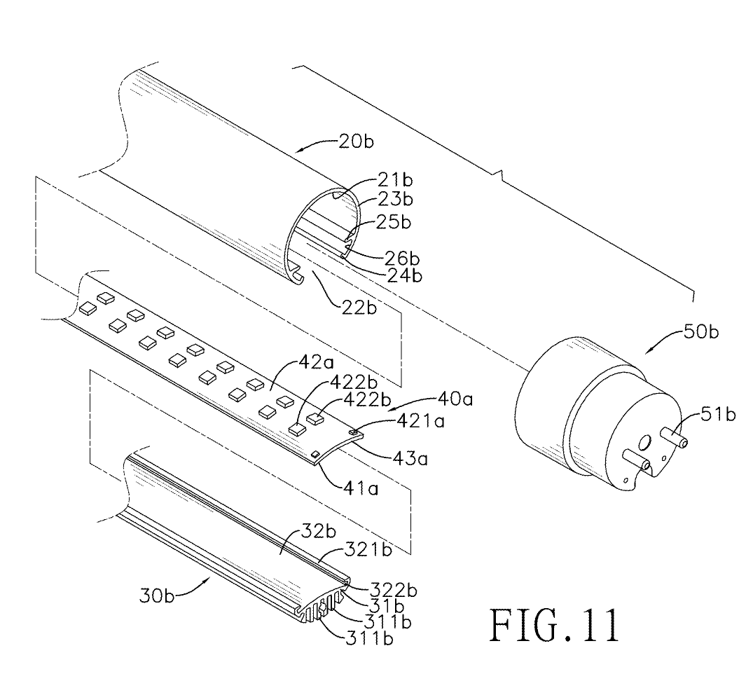

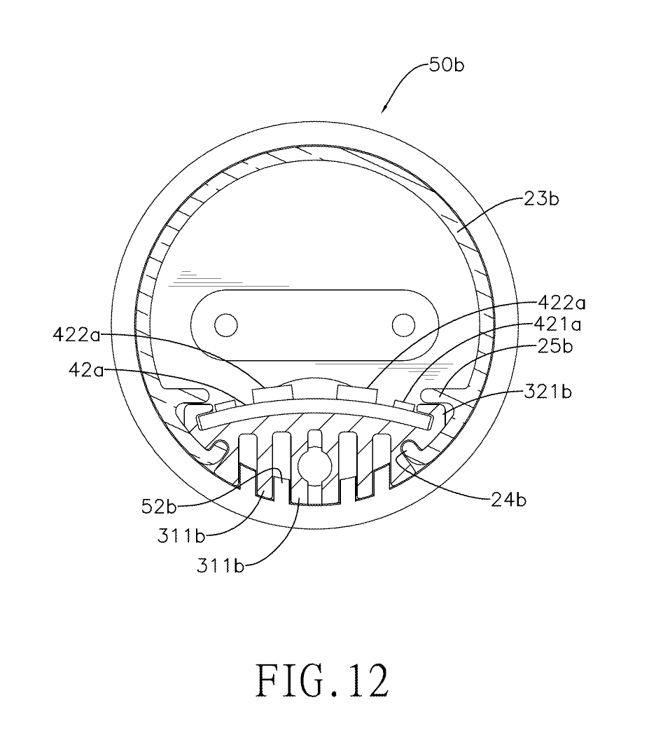

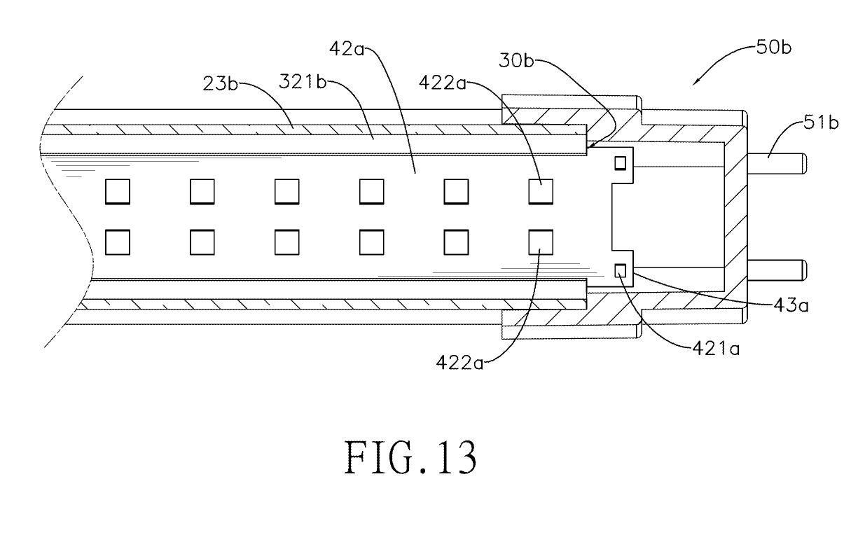

With reference to FIGS. 10 to 13, a third embodiment of an LED tube in accordance with the present invention comprises a tube body 10b, an LED light board 40a and two caps 50b.

The tube body 10b comprises a translucent tube shell 20b and a heat dissipating seat 30b.

The translucent tube shell 20b is electrically insulating and has two openings 21b, a gap 22b and two side walls 23b, two first ribs 24b, two second ribs 25b and two first slide tracks 26b. The gap 22b is formed through the translucent tube shell 20b along a longitudinal direction of the translucent tube shell 20b. The two side walls 23b are separated by the gap 22b. The two first ribs 24b are respectively formed on the two side walls 23b and adjacent to the gap 22b. The two second ribs 25b are respectively formed on the two side walls 23b, and are respectively located above the two first ribs 24b. Each first slide track 26b is formed between a corresponding one of the side walls 23b, the first rib 24b formed on said corresponding side wall 23b, and the second rib 25b formed on said corresponding side wall 23b.

The heat dissipating seat 30b is mounted in the gap 22b of the translucent tube shell 20b and bis made of metal. The heat dissipating seat 30b has two opposite sides in parallel to a longitudinal direction of the heat dissipating seat 30b, a bottom surface 31b and a top surface 32b opposite to the bottom surface 31b. The bottom surface 31b faces downward and has multiple fins 311a extending downward from the bottom surface 31b. The top surface 32b has two slide bars 321b and two slide tracks 322b. The two slide bars 321b extend upward from the top surface 32b and respectively along the two opposite sides of the heat dissipating seat 30b, wherein the two slide tracks 322b are respectively formed concave on the two slide bars 321b and face each other. In this embodiment, the top surface 32b is convex toward the translucent tube shell 20b.

The LED light board 40a is mounted in the tube body 10a and has two opposite sides slidably mounted in the two slide tracks 322b respectively, two opposite ends 43a connected to the two opposite sides of the LED light board 40a, a back surface 41a, and a luminous surface 42a opposite to the back surface 41a. The two ends 43a are respectively near the two openings 21b of the translucent tube shell 20b. The back surface 41a abuts the top surface 32b of the heat dissipating seat 30b. The luminous surface 42a has four electrical connecting parts 421a and multiple LED units 422a. Each two electrical connecting parts 421a are mounted on the luminous surface 42a and near a corresponding one of the ends 43a. In this embodiment, the back surface 41a is concave and corresponds in curvature to the convex top surface 32b of the heat dissipating seat 30b. The multiple LED units 422a are mounted on the luminous surface 42a and arranged in two lines, wherein the two lines of the LED units 422a are mounted on two beveled faces separated by a midline on the luminous surface 42a.

The caps 50b are respectively sleeved on the two openings 21b of the translucent tube shell 20b. Each cap 50b has an inner wall, two electrode pins 51b, multiple fin fixing parts 52b and a board fixing groove 53b. The two electrode pins 51b are mounted through the cap 50b and electrically connected to two corresponding ones of the electrical connecting parts 421a respectively. The multiple fin fixing parts 52b are formed on the inner wall of the cap 50b, wherein each fin fixing part 52b is mounted between two adjacent fins 311b of the multiple fins 311b. In this embodiment, the board fixing groove 53a is formed in the cap 50b is curved upward to correspond in curvature to a corresponding one of the ends 43a of the LED light board 40a.

In conclusion, the multiple LED units 422a mounted on the luminous surface 42a obliquely face the translucent tube shell 20b and increase an illumination range of the luminous surface 42a. An illumination angle of the LED tube in accordance with the present invention is also increased. Therefore, the LED tube glows evenly.

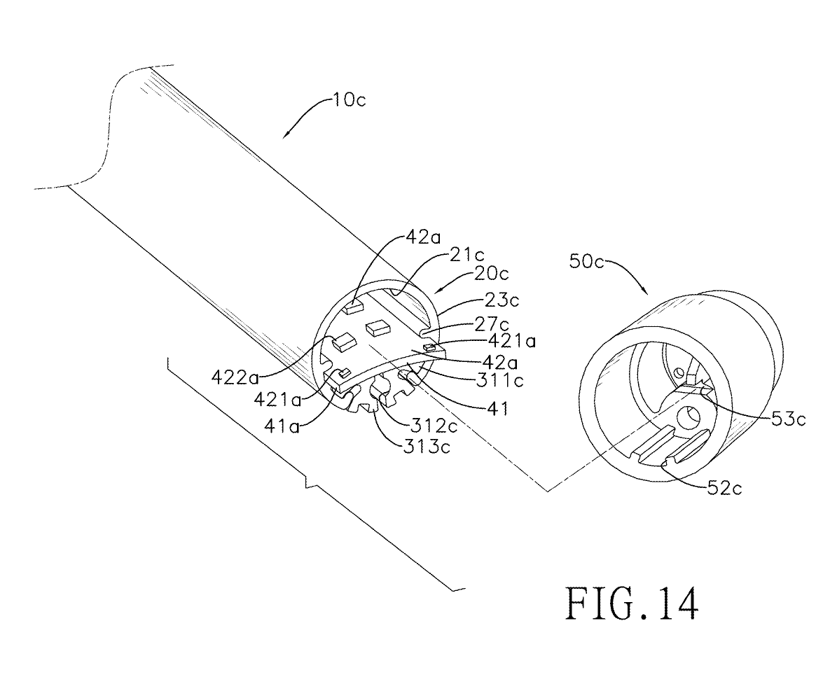

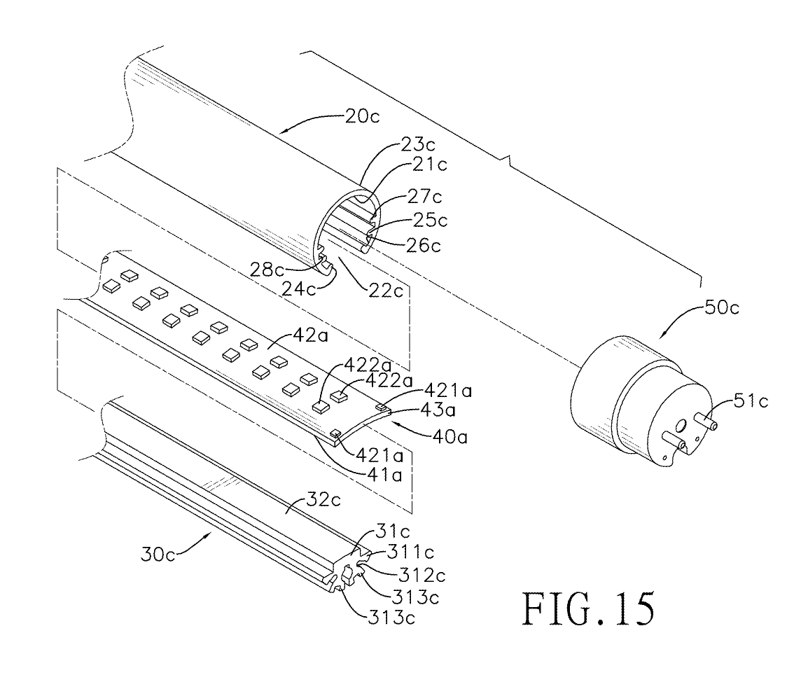

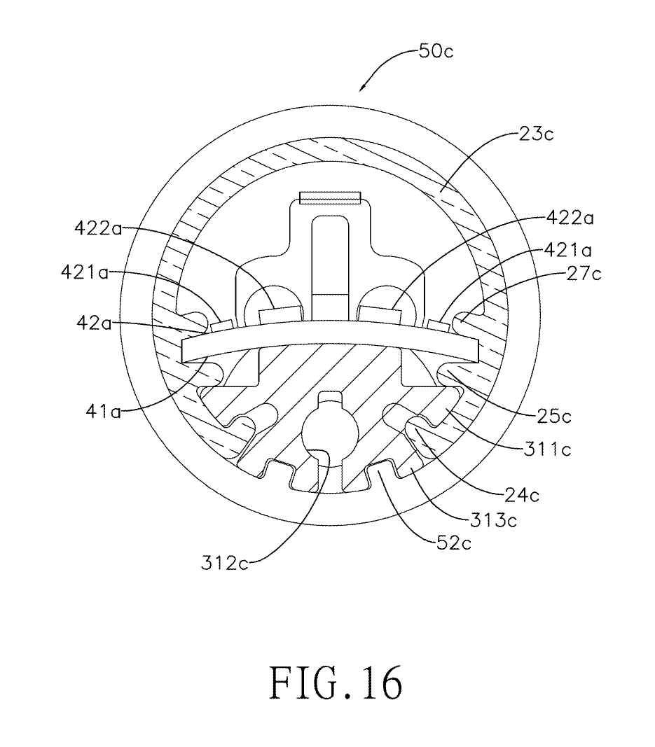

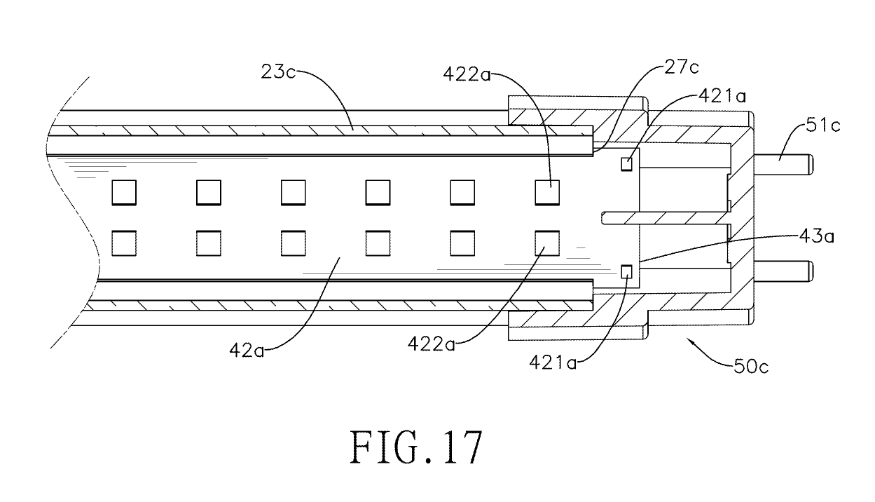

With reference to FIGS. 14 to 17, a fourth embodiment of an LED tube in accordance with the present invention comprises a tube body 10c, an LED light board 40a and two caps 50c. A structure of the LED light board 40a of the fourth embodiment is similar to that of the third embodiment. Therefore, the description of the structure of the LED light board 40a will not be repeated in following paragraphs.

The tube body 10c comprises a translucent tube shell 20c and a heat dissipating seat 30c.

The translucent tube shell 20c is electrically insulating and has two openings 21c, a gap 22c, two side walls 23c, two first ribs 24c, two second ribs 25c, two second slide tracks 26c, two third ribs 27c and two first slide tracks 28c. The gap 22c is formed through the translucent tube shell 20c along a longitudinal direction of the translucent tube shell 20c. The two side walls 23c are separated by the gap 22c. The two first ribs 24c are respectively formed on the two side walls 23c and adjacent to the gap 22c. The two second ribs 25c are respectively formed on the two side walls 23c, and are respectively located above the two first ribs 24c. Each first slide track 26c is formed between a corresponding one of the side walls 23c, the first rib 24c formed on said corresponding side wall 23c, and the second rib 25c formed on said corresponding side wall 23c. The two third ribs 27c are respectively formed on the two side walls 23c and respectively located above the two second ribs 25c. Each second slide track 28c is formed between a corresponding one of the side walls 23c, the second rib 25c formed on said corresponding side wall 23c, and the third rib 27a formed on said corresponding side wall 23c.

The heat dissipating seat 30c is mounted in the gap 22c of the translucent tube shell 20c and cis made of metal. The heat dissipating seat 30c has two opposite sides along a longitudinal direction of the heat dissipating seat 30c, a bottom surface 31c and a top surface 32c opposite the bottom surface 31c. The bottom surface 31c faces downward and has two slide bars 311c, two fins 312c and two fork parts 313c. The two slide bars 311c extend from the bottom surface 31c and respectively along the two opposite sides of the heat dissipating seat 30c, wherein the two slide bars 311c are slidably mounted in the two first slide tracks 26c of the translucent tube shell 20c respectively. Each fin 312c extends downward from the bottom surface 31c. The two fork parts 313c are respectively formed on the two fins 312c to increase a radiating area of the two fins 312c. In this embodiment, the top surface 32c is convex toward the translucent tube shell 20c.

In the fourth embodiment, the two opposite sides of the LED light board 40a are slidably mounted in the two second slide tracks 28c of the translucent tube shell 20c respectively.

The caps 50c are respectively sleeved on the two openings 21c of the translucent tube shell 20c. Each cap 50c has an inner wall, two electrode pins 51c, two fin fixing parts 52c and a board fixing groove 53c. The two electrode pins 51c are mounted through the cap 50c and are electrically connected to two of the corresponding electrical connecting parts 421a respectively. The two fin fixing parts 52c are formed on the inner wall and respectively correspond in position to the two fork parts 313a of the two fins 312a. In this embodiment, the board fixing groove 53c is curved upward to correspond in curvature to the convex LED light board 40a, wherein each end 43a of the LED light board 40a is mounted in a corresponding one of the board fixing grooves 53c.

According to the above description, the fourth embodiment of the LED tube in accordance with the present invention has advantages of the first, the second and the third embodiments. The two opposite sides of the heat dissipating seat 30c are slidably mounted in the two first slide tracks 26c respectively and the two opposite sides of the LED light board 40a are slidably mounted in the two second slide tracks 28c of the electrically insulating translucent tube shell 20c respectively to avoid a short-circuit between the heat dissipating seat 30c and the LED light board 40a. The two opposite ends 43a of the LED light board 40a extends out of the heat dissipating seat 30a to further extend distances between the electrical connecting parts 421a mounted on the ends 43a and the heat dissipating seat 30c. The two lines of the multiple LED units 422a obliquely face the translucent tube shell 20c and increase an illumination angle of the LED tube in accordance with the present invention.

Above all, each of the lengths of the LED light boards 40, 40a in the longitudinal direction of the LED light boards 40, 40a is longer than each of the lengths of the heat dissipating seat 30, 30a in the longitudinal direction of the heat dissipating seat 30, 30a, 30b, 30c. The two ends 43, 43a extend out of the heat dissipating seat 30, 30a, 30b, 30c. Each two electrical connecting parts 421, 421a are mounted near a corresponding one of the ends 43, 43a, that is, by mounting the electrical connecting parts 421, 421a near the two opposite ends 43, 43a of the lengthened LED light board 40, 40a, an internal creepage distance between the electrical connecting parts 421, 421a and the heat dissipating seat 30, 30a, 30b, 30c can be extended to improve electrical safety of the LED tube in accordance with the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED tube having long internal creepage distances comprising:
a tube body having:
a translucent tube shell having
two openings;
a gap formed through the translucent tube shell along a longitudinal direction of the translucent tube shell;
two side walls separated by the gap; and
a heat dissipating seat mounted in the gap;
an LED light board mounted in the tube body, wherein a length of the LED light board in a longitudinal direction of the LED light board is longer than a length of the heat dissipating seat in a longitudinal direction of the heat dissipating seat, and the LED light board having:
two opposite sides;
two opposite ends connected to the two sides of the LED light board and respectively near the two openings of the translucent tube shell, wherein the two opposite ends extend out of the heat dissipating seat;
a back surface abutting the heat dissipating seat; and
a luminous surface opposite to the back surface and facing toward the translucent tube shell, wherein the luminous surface has
four electrical connecting parts mounted on the luminous surface, wherein each two electrical connecting parts are respectively mounted near a corresponding one of the two opposite ends of the LED light board; and
two caps respectively mounted on the two openings of the translucent tube shell, wherein each cap has
two electrode pin electrically and respectively connected to a corresponding one of the electrical connecting parts of the LED light board.

2. The LED tube as claimed in claim 1, wherein
the translucent tube shell further comprises
two first slide tracks respectively formed on the two side walls; and
the heat dissipating seat further has
two opposite sides slidably mounted in the two first slide tracks of the translucent tube shell respectively.

3. The LED tube as claimed in claim 2, wherein
the heat dissipating seat further comprises
a bottom surface facing downward and having
multiple fins extending downward from the bottom surface;
a top surface opposite to the bottom surface and having
two slide bars extending upward from the top surface and respectively along the two opposite sides of the heat dissipating seat, wherein the two slide bars are slidably mounted in the two first slide tracks of the translucent tube shell respectively; and
two slide tracks respectively formed on the two slide bars, wherein the two slide tracks face each other; and
wherein the opposite sides of the LED light board are slidably mounted in the two slide tracks of the heat dissipating seat respectively.

4. The LED tube as claimed in claim 2, wherein
the translucent tube shell further comprises
two first slide tracks respectively formed on the two side walls; and
two second slide tracks respectively formed on the two side walls, wherein the two second slide tracks are respectively located above the two first slide tracks;
the two opposite sides of the heat dissipating seat are further slidably mounted in the two first slide tracks of the translucent tube shell respectively; and
the two opposite sides of the LED light board are slidably mounted in the two second slide tracks of the translucent tube shell respectively.

5. The LED tube as claimed in claim 3, wherein
the top surface of the heat dissipating seat is convex toward the translucent tube shell;
the back surface of the LED light board is concave and corresponds in curvature to the top surface of the heat dissipating seat; and
the luminous surface of the LED light board is convex toward the translucent tube shell.

6. The LED tube as claimed in claim 3, wherein each cap has
multiple fin fixing parts formed in the cap and respectively corresponding in position to two adjacent fins of the multiple fins of the heat dissipating seat.

7. The LED tube as claimed in claim 3, wherein
each fin of the heat dissipating seat has
a fork part formed on the fin; and
each cap has
multiple fin fixing parts formed in the cap and respectively corresponding in position to the multiple fork parts of the heat dissipating seat.

8. The LED tube as claimed in claim 1, wherein
each cap further comprises
a board fixing groove formed in the cap, wherein the board fixing groove corresponds in position to a corresponding one of the ends of the LED light board.

9. The LED tube as claimed in claim 4, wherein
each cap further comprises
a board fixing groove formed in the cap, wherein the board fixing groove corresponds in position to a corresponding one of the ends of the LED light board.

10. The LED tube as claimed in claim 8, wherein
each cap further comprises
a board fixing groove formed in the cap, wherein the board fixing groove corresponds in position to a corresponding one of the ends of the LED light board.

11. The LED tube as claimed in claim 5, wherein
each cap further comprises
a board fixing groove formed in the cap, wherein the board fixing groove is curved upwards and corresponds in curvature to a corresponding one of the ends of the LED light board.

12. The LED tube as claimed in claim 1, wherein the LED light board further comprises
multiple LED units mounted at intervals on the luminous surface along the longitudinal direction of the LED light board.

13. The LED tube as claimed in claim 4, wherein the LED light board further comprises
multiple LED units mounted at intervals on the luminous surface along the longitudinal direction of the LED light board.

14. The LED tube as claimed in claim 5, wherein the luminous surface of the LED light board further comprises
a midline along a longitudinal direction of the luminous surface;
two beveled faces separated by the midline; and
multiple LED units arranged in two lines, wherein the two lines of the multiple LED units are respectively mounted on the two beveled faces and along the longitudinal direction of the luminous surface.

15. The LED tube as claimed in claim 3 wherein
the heat dissipating seat further comprises
two semi-annular grooves respectively formed on two adjacent fins of the multiple fins, wherein the two semi-annular grooves face each other; and
each cap further comprises
a screw having
a screw rod mounted through the cap and between the two semi-annular grooves of the heat dissipating seat; and
a screw head connected to the screw rod and abutting the cap.

16. The LED tube as claimed in claim 7 wherein
the heat dissipating seat further comprises
two semi-annular grooves respectively formed on two adjacent fins of the multiple fins, wherein the two semi-annular grooves face each other; and
each cap further comprises
a screw having
a screw rod mounted through the cap and between the two semi-annular grooves of the heat dissipating seat; and
a screw head connected to the screw rod and abutting the cap.
